(19) United States
(12) Patent Application Publication
(10) Pub. No.: US 2016/0218405 A1
(43) Pub. Date: Jul. 28, 2016

(54) Use of High-Temperature Batteries for Ships

(71) Applicant: SIEMENS AKTIENGESELLSCHAFT, München (DE)

(72) Inventors: Michael KUEHNE, Fuerth (DE); Michael WYCISK, Moenkeberg (DE)

(21) Appl. No.: 15/025,962

(22) PCT Filed: Sep. 19, 2014
(86) PCT No.: PCT/EP2014/069971

§ 371 Date: Mar. 30, 2016

(30) Foreign Application Priority Data
Sep. 30, 2013 (DE) 10 2013 219 726.8

(51) Int. Cl. H01M 10/663; B60L 11/18; H01M 10/625; H01M 10/613; H01M 10/39

(52) U.S. Cl. CPC H01M 10/663; H01M 10/613; H01M 10/39; H01M 10/625; B60L 11/187; H01M 2220/20; B60L 2200/32; B60L 2240/545

(57) ABSTRACT

A method and arrangement for at least partially supplying an electrical system of a ship having at least one battery, wherein a high-temperature battery is utilized to obtain a ratio of installed capacity to usable energy which is better than that provided by conventional system, where the waste heat is conducted out of the battery via a duct system using a first heat transfer medium, and where the waste heat is made available for further use outside the battery.

### CROSS-REFERENCE TO RELATED APPLICATIONS

This is a U.S. national stage of application No. PCT/EP2014/069971 filed 19 Sep. 2014. Priority is claimed on German Application No. 10 2013 219 726.8 filed 30 Sep. 2013, the content of which is incorporated herein by reference in its entirety.

### BACKGROUND OF THE INVENTION

1. Field of the Invention

The invention relates to at least partially supplying an electrical system of a ship having at least one battery.

2. Description of the Related Art

Focus is increasingly turning to ships operated with low or even zero emissions, particularly for use on inland waterways, in order to reduce pollution especially in regions in which air pollution is already extremely high in any case. Also in the area of port facilities, regulatory measures are in force, for example, in order to ensure emissions from diesel engines during lay times are prevented as far as possible or completely eliminated. The power for the electrical system of the ship can be provided, e.g., via an electrical cable connection to the port infrastructure (depending on the total length). Alternatively, the power can be supplied to the loads with zero emissions via storage in batteries or conversion in fuel cells.

In the case of the exclusive or predominant use of stored electrical energy in ships, additional battery capacity would have to be provided to meet the thermal energy requirements for heating, particularly during cold times of year, and for cooling of the rooms/spaces, for example, during warm times of year. For the thermal energy, additional battery capacity would therefore have to be held available, which would involve both considerable specific weight and considerable capital and operating costs.

As no commercial use has yet been found for totally battery-powered ships, this problem has so far not arisen. Battery-powered pleasure craft are only used when the weather allows. In the case of hybrid propulsion, heat is presently diverted from the heat engine systems during operation. For lengthy lay times in port, heat stores could possibly be installed to meet the thermal energy requirement, but this would entail not only costs but also additional weight.

### SUMMARY OF THE INVENTION

It is thus an object of the invention is to provide a battery supply for vessels which at least reduces the foregoing disadvantages.

This and other objects and advantages are achieved in accordance with the invention by a ship having at least one high-temperature battery for at least partially supplying an electrical system, where the waste heat of the battery is extractable from the battery via pipework by a first heat transfer medium.

It is also an object to provide a method for at least partially supplying an electrical system of a ship having at least one high-temperature battery, where the waste heat is extracted from the battery via pipework by a first heat transfer medium.

When using high-temperature batteries, some of the electrical energy converted during charging and/or discharging accumulates at an elevated temperature level of, e.g., 300° C. If the battery cells are in contact with a suitable heat transfer medium, such as thermal oil, the transfer medium can be conveyed out of the battery via pipework and applied to a specific use. It is only when the available waste heat is insufficient for the intended use that some of the electrical energy must also be used for direct conversion into heat.

In the energy system of future “zero-emission” ships or in ships having suitable battery backup during the “zero-emission phase”, the utilization of the stored energy and in particular the ratio of capacity to be installed to usable energy can be improved by the inventive solution, as some of the energy that is used as thermal energy does not need to be additionally stored as electrical energy. Because of their elevated operating temperature with respect to ambient conditions, the high-temperature batteries are particularly independent of external temperatures and require, for example, no cooling such as lithium-ion or lead-acid batteries. Because of their relatively high energy per unit volume, they are also suitable in some cases for replacing existing lead-acid units. Advantages of the high-temperature batteries during charging and discharging (charge cycles) over lithium-ion batteries, for example, can not only be utilized, but generate additional added value.

The systemic integration of the batteries (not only electrical energy stores) enables the overall efficiency of ships having a considerable proportion of energy store utilization to be improved.

In an advantageous embodiment, the ship has at least one absorption air conditioning system, the store of which can be regenerated via the waste heat, or rather, in accordance with the method, the store of the absorption air conditioning system is regenerated via the waste heat. The waste heat is thus used to a certain extent for heating the air supplied via the air conditioning system and therefore for cooling rooms/spaces, for example.

In another advantageous embodiment, the ship has at least one heat exchanger by which heat can be transferred from the first heat transfer medium to a second heat transfer medium, or rather, in accordance with the method of the invention, heat is transferred from the first heat transfer medium to a second heat transfer medium via the heat exchanger. Heat extracted from the first heat transfer medium, which can be gaseous or liquid, is thereby transferred to the second heat transfer medium by means of the heat exchanger, such as from the primary heat carrier oil to air or steam, and therefore made directly available as process or heating energy.

In another advantageous embodiment, the ship has at least one power unit and/or a corresponding machine that can be kept warm by means of the waste heat, or rather, in accordance with the method, at least one power unit and/or machine is kept warm by the waste heat. These can thereby be kept warm and therefore operational if required even over lengthy period of time (as long as the batteries are being discharged).

To summarize, the invention relates to at least partially supplying an electrical system of a ship having at least one battery. In order to achieve a better ratio of installed capacity to usable energy in comparison to conventional solutions, the disclosed embodiments of the invention utilize a high-temperature battery, where the waste heat is extracted from the battery via pipework by a first heat transfer medium and used for other purposes.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a schematic block diagram of a ship having at least one high-temperature battery for at least partially supplying an electrical system of the ship; and

FIG. 2 is a flowchart of the method in accordance with the invention.

### DETAILED DESCRIPTION OF THE EXEMPLARY EMBODIMENTS

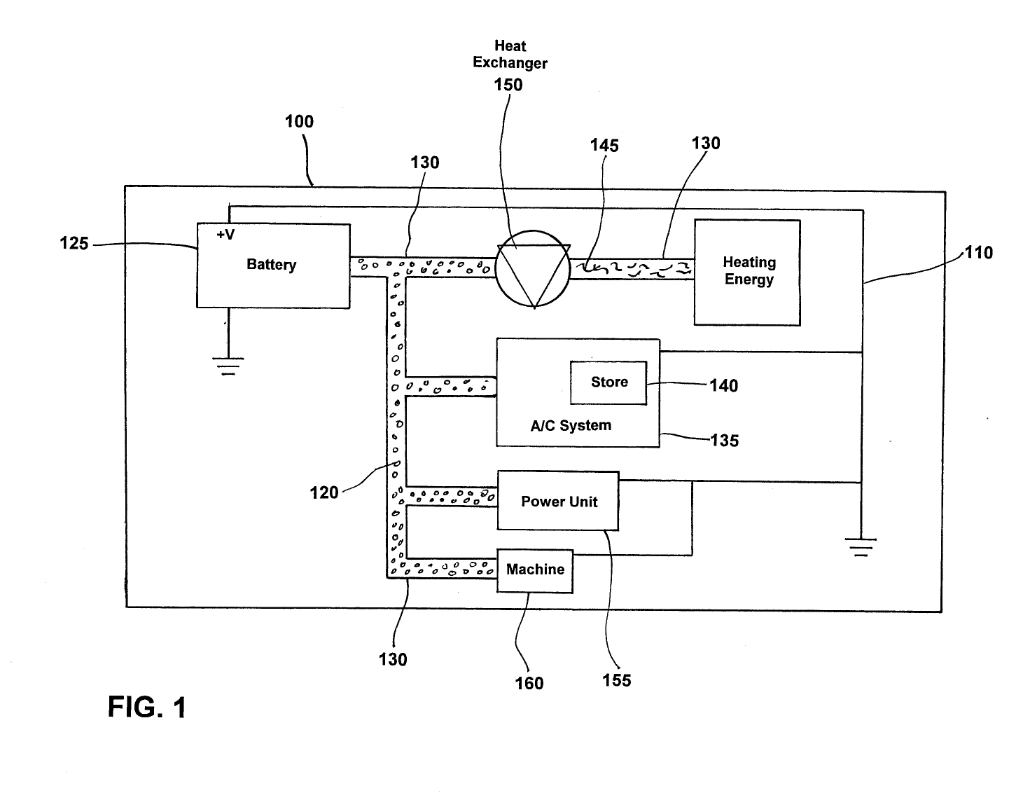

FIG. 1 is a schematic block diagram of a ship in accordance with the invention. With reference to FIG. 1, the ship is provided with an electrical system 110, a first heat transfer medium 120, and at least one high-temperature battery 125 for at least partially supplying the electrical system 110. Waste heat of the at least one high-temperature battery 125 is extracted from the at least one high-temperature battery 125 via pipework 130 by the first heat transfer medium 120. The ship is also provided with at least one absorption air conditioning system 135 having a store 140 that is regenerated via the waste heat of the at least one high-temperature battery 125.

In an embodiment, the ship also includes a second heat transfer medium 145, and at least one heat exchanger 150 by which heat is transferred from the first heat transfer medium 120 to the second heat transfer medium 145.

In another embodiment, the ship includes either at least one power unit 155 and/or at least one corresponding machine 160 which is kept warm via the waste heat.

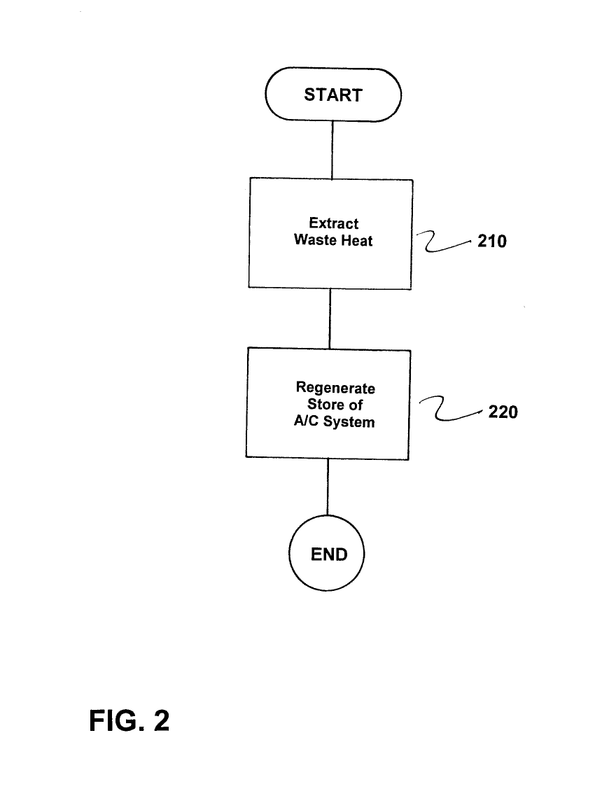

FIG. 2 is a flowchart of the method for at least partially supplying an electrical system of a ship having at least one high-temperature battery. The method comprises extracting waste heat from the least one high-temperature battery via pipework by a first heat transfer medium, as indicated in step 210. Next, a store of an absorption air conditioning system of the ship is regenerated via the extracted waste heat, as indicated in step 220.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A ship comprising:
an electrical system;
a first heat transfer medium;
at least one high-temperature battery for at least partially supplying the electrical system, waste heat of the at least one high-temperature battery being extracted from the at least one high-temperature battery via pipework by the first heat transfer medium; and
at least one absorption air conditioning system having a store which is regenerated via the waste heat of the at least one high-temperature battery.

10. The ship as claimed in claim 9, further comprising:
a second heat transfer medium; and
at least one heat exchanger by which heat is transferred from the first heat transfer medium to the second heat transfer medium.

11. The ship as claimed in claim 9, further comprising:
at least one of (i) at least one power unit and (ii) at least one corresponding machine which is kept warm via the waste heat.

12. The ship as claimed in claim 10, further comprising:
at least one of (i) at least one power unit and (ii) at least one corresponding machine which is kept warm via the waste heat.

13. A method for at least partially supplying an electrical system of a ship having at least one high-temperature battery; the method comprising:
extracting waste heat from the least one high-temperature battery via pipework by a first heat transfer medium; and
regenerating a store of an absorption air conditioning system of the ship via the extracted waste heat.

14. The method as claimed in claim 13 wherein heat is transferred from the first heat transfer medium to a second heat transfer medium via a heat exchanger.

15. The method as claimed in claim 13 wherein at least one of (i) at least one power unit and (ii) at least one machine is kept warm via the extracted waste heat.

16. The method as claimed in claim 14 wherein at least one of (i) at least one power unit and (ii) at least one machine is kept warm via the extracted waste heat.
